(19) United States
(12) Patent Application Publication
(10) Pub. No.: US 2014/0039988 A1
(43) Pub. Date: Feb. 6, 2014

(54) METHODS AND SYSTEMS FOR CONTROLLING TRAFFIC POLLUTION

(71) Applicants: Timothy Londergan, Seattle, WA (US); Feng Wan, Issaquah, WA (US); Kenichi Hashizume, Kitagunma-gun (JP); Christopher John Buntel, Singapore (SG)

(72) Inventors: Timothy Londergan, Seattle, WA (US); Feng Wan, Issaquah, WA (US); Kenichi Hashizume, Kitagunma-gun (JP); Christopher John Buntel, Singapore (SG)

(73) Assignee: EMPIRE TECHNOLOGY DEVELOPMENT LLC, Wilmington, DE (US)

(21) Appl. No.: 13/805,563

(22) PCT Filed: Jul. 31, 2012
(86) PCT No.: PCT/US12/49009

§ 371 Date: Dec. 19, 2012

(51) Int. Cl. G06Q 30/02

(52) U.S. Cl. CPC G06Q 30/0207
USPC 705/14.1

(57) ABSTRACT

Methods and systems for controlling traffic pollution are disclosed. An environmental score and a financial incentive based on the environmental score may be provided. A vehicle having a pollution recording unit may be provided. The pollution recording unit may be configured to provide an environmental score based on the pollution behavior of the vehicle. A financial incentive may be determined based on the environmental score at a processing device communicatively coupled to the pollution recording unit. The financial incentive may be provided to an operator of the vehicle.

### BACKGROUND

The burning of fossil fuels releases several pollutants, including carbon dioxide (CO₂), carbon monoxide (CO), nitrogen oxides (NOₓ), sulfur oxides (SO_{X}), volatile organic compounds (VOCs), and various particulate matter. These pollutants negatively impact the natural environment and public health, for instance, by decreasing surrounding air and water quality. Vehicle emissions are a major source of fossil fuel pollutants. Efforts to curb vehicle emissions have included technological solutions aimed at generating cleaner emissions, high occupancy vehicle (HOV) lane restrictions, mandated vehicle emissions testing, car tab fees, and ordinances limiting the idling of commercial vehicles. Despite these and other efforts, the volume of pollutants generated by vehicle emissions continues to rapidly expand as emission reductions are more than offset by emission increases. A primary factor behind increased vehicle emissions is the continuous rise in the number and use of vehicles on roadways worldwide, especially in highly congested areas. However, for numerous reasons, limiting the number of vehicles is not a practical option for managing vehicle emissions. As such, individualized incentives would be beneficial in influencing vehicle operator behavior and efforts towards reducing vehicle emissions.

### SUMMARY

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

In an embodiment, a method of controlling traffic pollution may include providing a vehicle having at least one pollution recording unit configured to provide an environmental score based on at least one pollution behavior of the vehicle and associated with a financial incentive, and calculating the financial incentive based on the environmental score at a processing device operably connectable to the pollution recording unit.

In an embodiment, a system for measuring a vehicle's pollution may include a pollution monitoring unit in electronic communication with a vehicle, the pollution monitoring unit configured to provide an environmental score based on at least one pollution behavior of the vehicle and associated with a financial incentive, and a processing device operably connected to the pollution monitoring unit and configured to calculate the financial incentive based on the environmental score.

In an embodiment, a vehicle may include a propulsion device configured to emit a quantity of exhaust and a pollution measuring system that may include a pollution monitoring unit in electronic communication with the vehicle, the pollution monitoring unit configured to provide an environmental score based on at least one pollution behavior of the vehicle and the quantity of exhaust emitted by the propulsion device, where the environmental score is associated with a financial incentive, and operably connect to a processing device configured to calculate the financial incentive based on the environmental score.

In an embodiment, a method of providing a financial incentive to an operator of a vehicle may include receiving an environmental score for a vehicle, where the environmental score is determined by a pollution recording unit, determining a financial incentive based upon the environmental score, and providing the financial incentive to the operator of the vehicle.

### BRIEF DESCRIPTION OF THE FIGURES

FIG. 1 depicts a flow diagram for an illustrative method of determining a financial incentive according to an embodiment.

FIG. 2 depicts a flow diagram for an illustrative method of providing a financial incentive to a vehicle operator according to an embodiment.

FIG. 3 depicts a block diagram for an illustrative system for determining a financial incentive according to an embodiment.

FIG. 4 depicts a block diagram of an illustrative computing device that may be used to contain or implement program instructions according to an embodiment.

### DETAILED DESCRIPTION

The following terms shall have, for the purposes of this application, the respective meanings set for the below.

“Environmental impact” refers to the actual or potential effect an action or inaction may have on aspects of the environment, such as air or water quality. An environmental impact may comprise deleterious effects such as pollution, increased energy consumption or waste products, and/or the like.

“Pollution data” refers to information associated with the release of pollution by a vehicle. The pollution data may be monitored by a sensor associated with the vehicle, for example, a sensor configured to measure vehicle exhaust gases. Example pollutants may include, but are not limited to, carbon dioxide (CO₂), carbon monoxide (CO), nitric oxide (NO), nitrogen dioxide (NO₂), sulfur dioxide (SO₂), volatile organic compounds (VOCs), nanoparticles and other various particulate matter, and combinations thereof.

“Pollution behavior” refers to driving conditions associated with a vehicle. For example, pollution behavior may be indicative of the environmental impact of vehicle operation based on driver behavior. Driving conditions may include, without limitation, vehicle pollutant levels, a time of day, a route, and a duration associated with operation of the vehicle.

An “environmental score” refers to a value assigned to a vehicle operator based on the pollution behavior, the pollution data, or both, associated with a vehicle. The environmental score may operate to quantify the environmental impact of operating a vehicle under certain driving conditions. The relationship between the absolute value of the environmental score and the environmental impact may depend on the scoring system. For example, in a first system, a higher environmental score may indicate a greater environmental impact, while a lower environmental score may indicate a lesser environmental impact. In the alternative, a second system may provide that a higher environmental score may indicate a lesser environmental impact, while a lower environmental score may indicate a greater environmental impact. As such, depending on the scoring system, the environmental score may be configured to indicate the environmental benefits or environmental damage associated with a particular vehicle and/or driving behavior.

“Pollution recording unit” refers to an electronic device configured to monitor, measure, and/or record pollution information for a vehicle. The pollution information may include pollution data, pollution behavior, or both. The pollution recording unit may be coupled to sensors or other electronic devices configured to measure one or more aspects of the pollution data or pollution behavior. For example, an exhaust sensor may be connected to the pollution recording unit for providing pollution data for one or more pollutants. In another example, the pollution recording unit may be in electronic communication with a global positioning system (GPS) device or computing device associated with the vehicle (e.g., an on-board or cloud-based computing device) and arranged to provide pollution behavior information.

A “financial incentive” refers to an economic reward or penalty designated for a vehicle operator according to the environmental impact of the vehicle. The financial incentive may be determined based on the environmental score. For example, if a higher environmental score indicates a greater economic impact, then the lower the environmental score, the higher the economic reward or the lower the economic penalty, and the higher the environmental score, the lower the economic reward or the higher the economic penalty. The financial incentive may include, without limitation, a fee associated with operation of the vehicle, such as a car tab fee or supplemental registration or inspection fee, a tax refund or credit, a government citation (e.g., a “ticket”), a car manufacturer credit, an oil company credit, a dealership service credit, or a combination thereof. The financial incentive is configured to modify vehicle operator behavior to reduce the environmental impact of the vehicle.

“Congestion score” refers to a value assigned to a roadway, route, or geographic area indicative of the level of traffic congestion associated with the roadway, route, or geographic area. The roadway or geographic area may comprise a road, street, highway, city, town, or other municipality or portions thereof. For instance, if a particular area has a relatively high amount of traffic congestion, the congestion score would be higher for the area. Conversely, if a particular area has a relatively low amount of traffic congestion, the congestion score would be lower for the area.

“Air pollution degree” refers to a value assigned to a roadway, route, or geographic area associated with the level of air pollution or an acceptable level of air pollution for the particular roadway, route, or geographic area. The air pollution degree may be focused on one or more specific pollutants or may be indicative of an overall air quality level. For example, a higher air pollution degree may be associated with elevated levels of air pollution, and a lower air pollution degree may be associated with lower levels of air pollution.

One problem with conventional vehicle emission reduction methods is that they do not adequately influence a main cause behind vehicle emissions: vehicle operator behavior. For example, they are not sufficiently tied to driving conditions that significantly impact the environment and they are not implemented in a manner that effectively changes driver behavior. As such, a need exists for a technology that is capable of meaningful valuing vehicle pollution information. Furthermore, a need exists for a valuation and incentive system that encourages driving behavior that reduces the environmental impact of vehicle emissions.

This disclosure identifies methods and systems for controlling traffic pollution using financial incentives based on vehicle pollution information. In particular, this disclosure identifies methods and systems for determining an environmental score of a vehicle based on pollution behavior and pollution data associated with the vehicle, and calculating a financial incentive based on the environmental score.

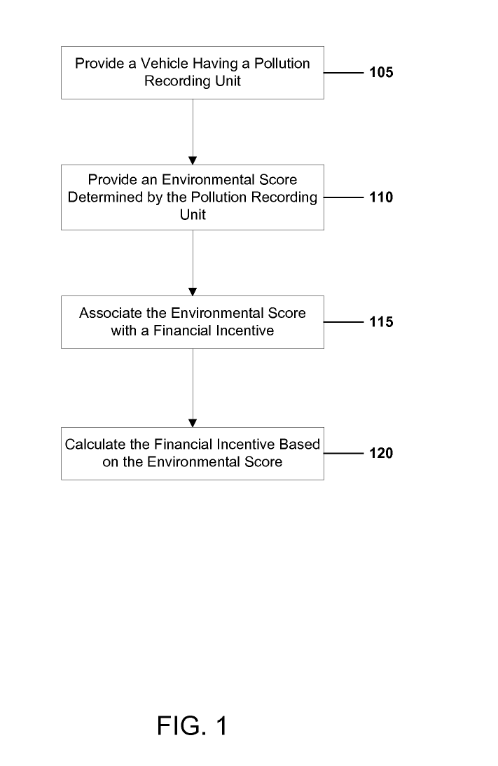

FIG. 1 depicts a flow diagram for an illustrative method of determining a financial incentive according to an embodiment. As shown in FIG. 1, a vehicle having a pollution recording unit may be provided 105. The vehicle that is provided 105 may comprise a vehicle configured to generate pollutants during operation. The pollutants may be released into the environment, for instance, through an exhaust system. In an embodiment, the vehicle may comprise, without limitation, an automobile, a truck, an airplane, or a watercraft. Illustrative and non-restrictive examples of pollutants may include CO₂, CO, NO, NO₂, NOₓ, SO₂, SOₓ, VOCs, nanoparticles and other various particulate matter, combinations thereof, and any other such designated substances.

The pollution recording unit that is provided 105 may be configured to monitor pollution data, pollution behavior, or both, associated with a vehicle. The pollution recording unit that is provided 105 may comprise one or more sensors positioned to monitor pollutants generated by a vehicle. The pollution data may include information pertaining to the release of pollutants during operation of a vehicle. For example, one or more gas and/or particle sensors may be located along the exhaust path of a vehicle, such as being attached to the end of an exhaust pipe or integrated within an exhaust pipe. In an embodiment, sensors may include, without limitation, solid electrolyte CO₂ sensors, catalytic combusting sensors (e.g., for unburned hydrocarbon gases), electrochemical CO gas sensors, Taguchi gas sensors (TGS), and any other type of sensor capable of detecting pollutants. In another embodiment, the pollution data may be completely or partially estimated based on known vehicle information (e.g., pollution generation statistics) alone or in combination with other information, such as vehicle speed and operation duration.

The pollution recording unit that is provided 105 may comprise one or more devices configured to monitor the pollution behavior of a vehicle, including the position, speed, driving distance, time of day, traffic information, and the amount of one or more pollutants. In an embodiment, the pollution behavior may be proportional to an amount of one or more pollutants. The pollution behavior may indicate the impact of vehicle operation on the environment because the operation of a vehicle may have a greater effect on the environment depending on when, where, how, and under what traffic conditions the vehicle is being operated. For example, the environmental impact may be greater during rush hour (i.e., peak driving time), in densely populated areas, in high pollution areas, on congested or highly travelled roadways, over extended periods of time, and at increasing levels of pollutant exhaust. In an embodiment, the pollution behavior may be monitored by an exhaust sensor and/or a navigation system device, such as a global positioning system (GPS) device. For example, the GPS device may provide location, speed, duration, and traffic congestion information, and air pollution/quality information. In another embodiment, the pollution recording unit may be connected to a computing device or sensor coupled to the vehicle, such as an on-board computing system or gas sensor, arranged to provide the pollution behavior information.

In an embodiment, the GPS device may provide suggested routes, for example, based on traffic or pollution information, including, without limitation, a congestion score or an air pollution degree. The congestion score may comprise a value indicative of the level of traffic congestion of a particular area, such as a roadway, section of roadway, route, municipality, separately or in combination. For instance, if a particular area has a relatively high amount of traffic congestion, the congestion score would be higher for the area. Conversely, if a particular area has a relatively low amount of traffic congestion, the congestion score would be lower for the area. The air pollution degree may comprise a value indicative of the level of air pollution, either actual or estimated, or an acceptable level of air pollution for a particular area. For example, a higher air pollution degree may be associated with elevated levels of air pollution, and a lower air pollution degree may be associated with lower levels of air pollution. The GPS device may completely or partially determine the congestion score, air pollution degree, or both, or may receive the congestion score, air pollution degree, or both, from a third party, such as an environmental information service or municipality. In an embodiment, the GPS device may suggest routes that have a low congestion score or that are associated with a lower air pollution degree. In another embodiment, the environmental score may be proportional to the congestion score and/or the air pollution degree.

An environmental score may be determined 110 by the pollution recording unit associated with the vehicle. In an embodiment, the environmental score may be determined based on the pollution behavior of the vehicle. The environmental score may comprise a value that is increased or decreased based on the environmental impact of the pollution behavior (or vice versa if a higher score indicates a lower environmental impact). For example, if the pollution recording unit determines that the vehicle is being driven on a historically high traffic roadway or during rush hour, the environmental score may be increased. Conversely, if the pollution recording unit determines that the vehicle is being driven during a non-peak time or in a low pollution area, the environmental score may be decreased. In an embodiment, the pollution behaviors may be weighted, such that certain pollution behaviors may have a greater effect on the environmental score. For example, driving a vehicle during a non-peak time may decrease the environmental score by one, while driving a vehicle on a congested roadway may increase the environmental score by two. The environmental score may be determined 110 based on the collective effect of the pollution behaviors associated with a vehicle. For instance, the pollution behaviors may be added to or subtracted from an environmental score to generate a net environmental score value.

In an embodiment, the environmental score may be determined 110 based on the pollution data associated with a vehicle. For example, the pollution recording unit may receive pollution data associated with a vehicle comprising information about pollutants released by the vehicle during operation. The environmental score may be calculated based on the types and amounts of pollutants included in the pollution data. For instance, if the pollution data indicates an amount of CO₂ above a certain threshold, the environmental score may be increased. Conversely, if the pollution data indicates that the amount of CO₂ is below the threshold, the environmental score may be decreased. The pollutants may be weighted such that certain pollutants and amounts thereof may differentially affect the environmental score. For example, a certain amount of substance A may increase the environmental score by one, while the same amount of substance B may increase the environmental score by two. The effect of pollutants on the environmental score may depend on the amount of the pollutant along a sliding scale, such that for each interval amount of pollutant, the environmental score may be increased or decreased accordingly. For example, for each mg/m³ of compound A over a threshold amount, the environmental score may be increased by one and for each mg/m³ of compound A under the threshold amount, the environmental score may be decreased by one.

In another embodiment, the environmental score may be determined 110 based on a combination of the pollution data and the pollution behavior. The pollution recording unit may calculate the environmental score based on the collective effect of the pollution data and the pollution behavior. For example, a threshold amount of compound A may increase the environmental score by two, while driving during a non-peak time may decrease the environmental score by one. In another example, a threshold amount of compound B may increase the environmental score by two, and the environmental score may subsequently be multiplied by a route factor configured to score routes based on traffic congestion. The environmental score may be directed to one or more elements, such as a specific pollutant (e.g., CO₂) or driving condition (e.g., traffic congestion), or may represent an overall pollution factor for a vehicle. For example, an entity associated with the environmental score, such as a local government entity, may be concerned with one major pollutant, congestion on a certain set of roadways, or a specific class of vehicles (e.g., commercial vehicles).

In an embodiment, the pollution recording unit may access information relevant to calculating an environmental score in addition to pollution behavior or pollution data. For example, the pollution recording unit may comprise or obtain historical traffic pattern, traffic congestion, pollution, geographic information, and route information. Additionally, the pollution recording unit may access data configured to calculate the environmental score, such as constants, multiplication factors, formulas, predetermined ranges, and historical environmental scores associated with vehicles and/or vehicle operators.

The environmental score may be associated with a financial incentive 115. One or more entities may use the financial incentive to economically reward or penalize vehicle operators based on the environmental impact of a vehicle. Example entities include, without limitation, government entities (e.g., municipalities, taxing authorities, federal, state, and local governments), vehicle dealerships and repair service centers, fuel and oil companies, vehicle component manufacturers and suppliers, and environmental rating or sustainability organizations. The financial incentives may include, without limitation, cash, fees, taxes, refunds, credits, or other economic methods for inducing vehicle operator behavior provided by an entity. For example, a financial incentive may comprise a car tab fee, an environmental sustainability scorecard, a vehicle dealership credit, or a tax credit. An entity may receive environmental scores and relate them to financial incentives used by the entity, for instance, as part of a vehicle emissions reduction strategy. For example, a municipality may impose a tax on vehicle operators having an environmental score above a threshold amount and may provide a tax credit (e.g., a “green credit”) to local residents having an environmental score below a threshold amount where a higher environmental score indicates a greater environmental impact. The tax and tax credit may operate to encourage driving habits that have a diminished impact on the environment.

The financial incentive may be calculated based on the environmental score 120. In an embodiment, the environmental score may be determined by the pollution recording unit and communicated to a processing device, such as a processing device coupled to a computing device that calculates the financial incentive. The financial incentive may be configured such that a lower environmental score results in a higher economic reward or lower economic penalty and a higher environmental score results in a lower economic reward or higher economic penalty on a scale where a higher environmental score indicates a greater negative environmental impact. The financial incentive may be calculated 120 by determining a financial penalty or reward whose value is directly affected by the environmental score, including, without limitation, multiplying or dividing/adding/subtracting the financial incentive base value by/to/from the environmental score (or vice versa) alone or in combination with one or more financial incentive calculation factors (e.g., a constant value based on the time of year, resident location, etc.).

In an embodiment, the financial incentive may comprise a value that is the product of multiplying the environmental score and a financial incentive base value. In one example, a local income tax credit may equal a quarter percent tax reduction for each unit of the environmental score below a threshold value, such that a local resident having an environmental score two units below the threshold may receive a half percent local income tax credit. In another example, an environmental sustainability scoring organization may reduce the score of a commercial vendor having a fleet of commercial vehicles for each vehicle having an associated score above a threshold environmental score value.

In an embodiment, the financial incentive and/or the environmental score may be affected by one or more vehicle operator activities, such as activities having a positive environmental impact, or encouraged by an entity associated with the financial incentive and/or the environmental score. For example, the financial incentive and/or the environmental score may be reduced or increased if a vehicle operator uses public transit, carpools, and/or drives a vehicle having a fuel efficiency rating above or below a fuel efficiency threshold. The activity may be registered, for instance, directly with the entity associated with the financial incentive and/or the environmental score or through a setting, menu, user interface, or the like of the pollution recording unit.

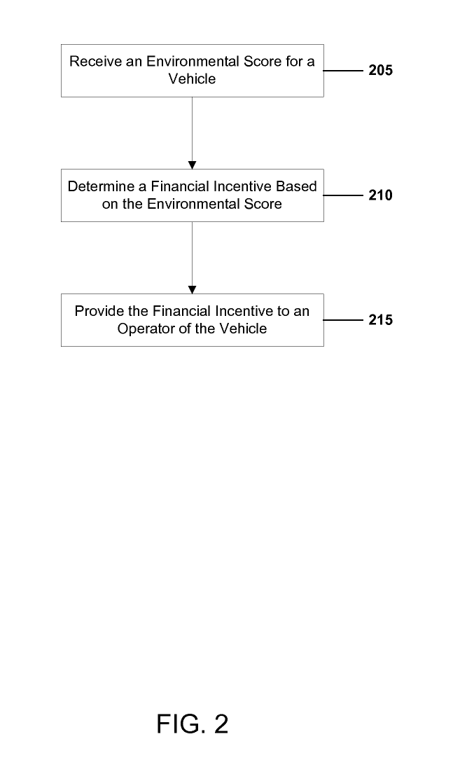

FIG. 2 depicts a flow diagram for a method of providing a financial incentive to a vehicle operator according to an embodiment. As shown in FIG. 2, an environmental score for a vehicle may be received 205. In such an embodiment, the environmental score may be determined by a pollution recording unit associated with the vehicle, such as is described in reference to FIG. 1 above. The environmental score may be transmitted by the pollution recording unit and received by a processing device communicatively coupled to the pollution recording unit. For example, the processing device may comprise a processing unit arranged within a computing device of an entity associated with the financial incentive and/or the environmental score.

A financial incentive may be determined based on the environmental score 210. For instance, the financial incentive may comprise an economic reward or penalty whose value is directly or indirectly determined by the environmental score. In an embodiment, the financial incentive may comprise an economic penalty, such as a tax or citation, imposed if the environmental score is above a threshold value. In another embodiment, the financial incentive may comprise an economic reward having a value equal to the environmental score multiplied by a constant factor. For instance, the economic reward may equal a vehicle registration fee credit having a dollar amount equal to the pollution factor multiplied by two. In one example, the financial incentive may comprise a cash rebate or service credit from a car manufacturer or car dealership, where the cash rebate or service credit decreases as the environmental score increases. In another example, the financial incentive may comprise a tax credit or refund, where the tax credit or refund decreases as the environmental score increases.

The financial incentive may be provided to the operator of a vehicle 215. For example, the financial incentive may be communicated to or associated with the operator of a vehicle by an entity associated with the financial incentive, such as a municipality, manufacturer, environmental rating organization, vehicle dealership or repair entity. The financial incentive may be provided 215 in various forms, including, but not limited to, a credit, voucher, coupon, cash, rebate, fee, or combinations thereof.

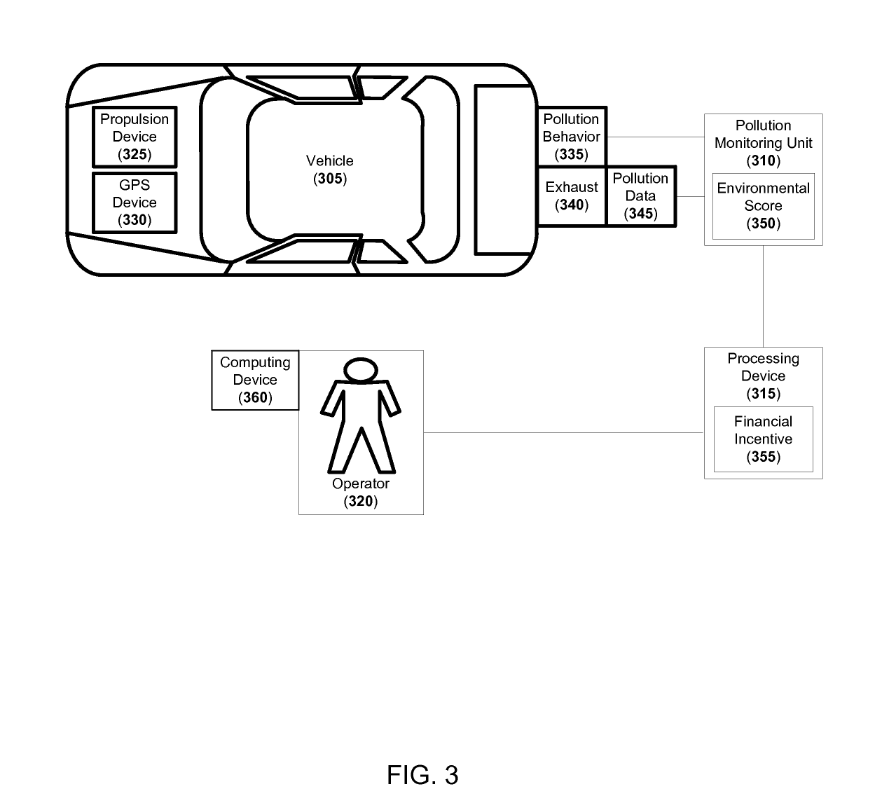

FIG. 3 depicts a block diagram for an illustrative system for determining a financial incentive according to an embodiment. As shown in FIG. 3, the system 300 may include a vehicle 305 comprising a propulsion device 325. The vehicle 305 may include, without limitation, an automobile, truck, motorcycle, airplane, helicopter, watercraft, or any other motorized vehicle or machinery generating pollutants during operation. The propulsion device 325 may comprise any apparatus or system configured to drive a vehicle 305, such as a motor or engine (e.g., internal combustion engine, electric motor, and the like). Pollutants may be generated by the propulsion device 325 during operation. The vehicle 305 may include an exhaust 340 arranged to receive all or some of the pollutants and to release them into the environment. A GPS device 330 may be associated with the vehicle 305, providing information including geographic location, route, suggested route, speed, traffic, and pollution data. The vehicle 305 may comprise other components typical for its type and class.

A pollution monitoring unit 310 may be coupled to the vehicle 305. For example, the pollution monitoring unit 310 may be in electronic communication with the vehicle 305 and connected to the exhaust 340, such as through one or more sensors configured to measure pollutants handled by the exhaust 340. The pollution monitoring unit 310 may monitor pollution data 345 associated with the vehicle 305 through the connection with the exhaust 340. Alternatively or additionally, the pollution monitoring unit 310 may monitor pollution behavior 335 associated with the vehicle 305. Pollution behavior 335 may involve driving conditions of the vehicle 305, including, without limitation, time of day, location, duration, route, congestion score, and air pollution degree. The pollution monitoring unit 310 may generate an environmental score 350 based on the pollution data 345 and/or the pollution behavior 335, such as is described in reference to the figures above.

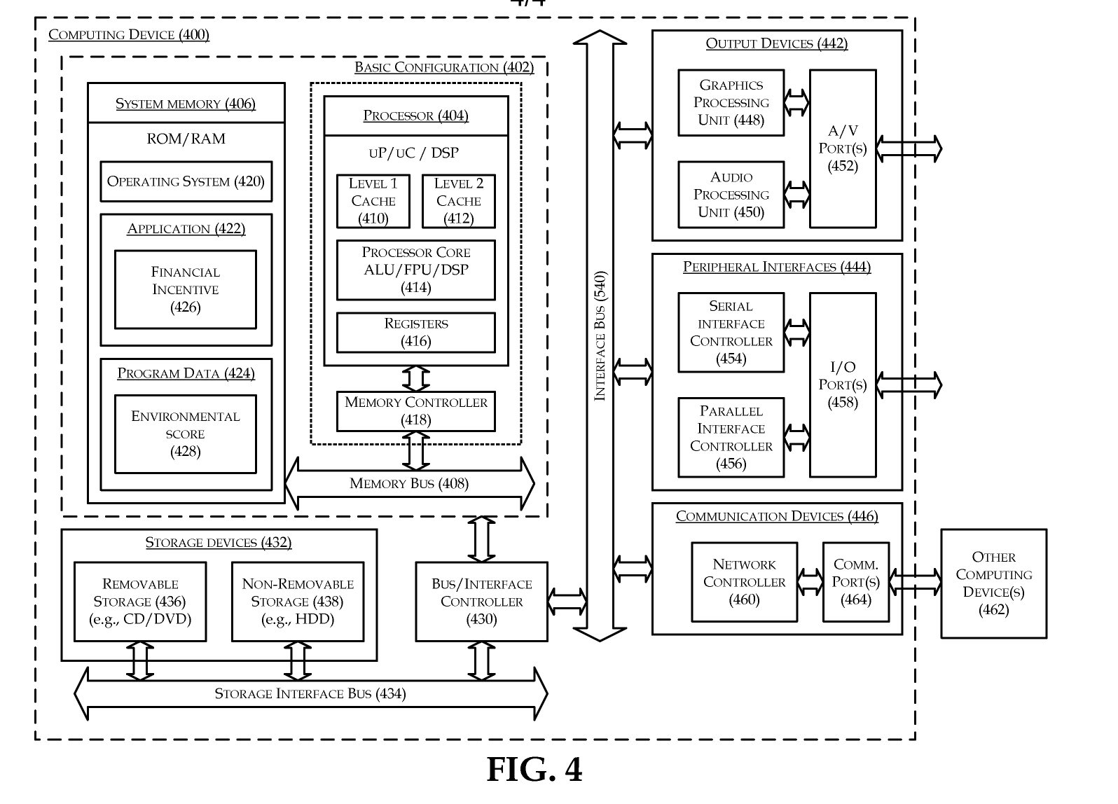

A processing device 315 may be communicatively coupled to the pollution monitoring unit 310. An example processing device 315 is disclosed in reference to FIG. 4. The environmental score 350 may be transmitted by the pollution monitoring unit 310 and received by the processing device 315. A financial incentive 355 may be determined by the processing device 315 based on the received environmental score 350, such as is described in reference to the figures above. For example, the processing device 315 may determine a tax credit financial incentive 355 that is the product of multiplying the environmental score 350 by a constant, such as twenty-five percent. As such, an environmental score 350 of four calculated by the pollution monitoring unit 310 and communicated to the processing device 315 may result in a tax credit of one. The processing device 315 may be operated by an entity associated with the financial incentive 355, such as a municipality, environmental rating agency, or a vendor coordinating an environmental initiative aimed at reducing vehicle emissions.

The financial incentive 355 may be communicated to a vehicle operator 320 associated with the vehicle 305. For example, each vehicle operator 320 may register a vehicle 305 with the entity associated with the financial incentive 355. The entity associated with the financial incentive 355 may communicate the financial incentive through various means, such as sending an electronic message (e.g., electronic mail (e-mail) or short message service (SMS)) or making the financial incentive otherwise available (e.g., via a website) to a computing device 360 associated with the vehicle operator 320. Example computing devices 360 may include cell phones, smart phones, personal computers (PCs), laptop computers, GPS devices, and tablet computing devices. The vehicle operator 320 may then redeem or pay any economic value associated with the financial incentive 355. In this manner, the financial incentive 355 may operate to influence the behavior of the vehicle operator 320 to operate the vehicle 305 in a manner that produces a lower environmental score 350. For example, the operator may be encouraged to operate a vehicle 305 that generates less pollution as indicated by the pollution data 345 and/or to operate a vehicle in driving conditions having a diminished negative environmental impact as indicated by the pollution behavior 335.

FIG. 4 is a block diagram illustrating an example computing device 400 that is arranged for generating a financial incentive based on an environmental score in accordance with the present disclosure. In a very basic configuration 402, computing device 400 typically includes one or more processors 404 and a system memory 406. A memory bus 408 may be used for communicating between processor 404 and system memory 406.

Depending on the desired configuration, processor 404 may be of any type including but not limited to a microprocessor (μP), a microcontroller (μC), a digital signal processor (DSP), or any combination thereof. Processor 404 may include one more levels of caching, such as a level one cache 410 and a level two cache 412, a processor core 414, and registers 416. An example processor core 414 may include an arithmetic logic unit (ALU), a floating point unit (FPU), a digital signal processing core (DSP Core), or any combination thereof. An example memory controller 418 may also be used with processor 404, or in some implementations memory controller 418 may be an internal part of processor 404.

Depending on the desired configuration, system memory 406 may be of any type including but not limited to volatile memory (such as RAM), non-volatile memory (such as ROM, flash memory, etc.) or any combination thereof. System memory 406 may include an operating system 420, one or more applications 422, and program data 424. Application 422 may include a financial incentive 426 that is arranged to influence the behavior of a vehicle operator as described in reference to FIGS. 1 and 2. Program data 424 may include an environmental score 428 that may be useful for indicating an environmental impact of the operation of a vehicle as is described herein. In some embodiments, application 422 may be arranged to operate with program data 424 on operating system 420 such that a financial incentive may be generated and communicated to a vehicle operator. This described basic configuration 402 is illustrated in FIG. 4 by those components within the inner dashed line.

Computing device 400 may have additional features or functionality, and additional interfaces to facilitate communications between basic configuration 402 and any required devices and interfaces. For example, a bus/interface controller 430 may be used to facilitate communications between basic configuration 402 and one or more data storage devices 432 via a storage interface bus 434. Data storage devices 432 may be removable storage devices 436, non-removable storage devices 438, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 406, removable storage devices 436 and non-removable storage devices 438 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 400. Any such computer storage media may be part of computing device 400.

Computing device 400 may also include an interface bus 440 for facilitating communication from various interface devices (e.g., output devices 442, peripheral interfaces 444, and communication devices 446) to basic configuration 402 via bus/interface controller 430. Example output devices 442 include a graphics processing unit 448 and an audio processing unit 450, which may be configured to communicate to various external devices such as a display or speakers via one or more A/V ports 452. Example peripheral interfaces 444 include a serial interface controller 454 or a parallel interface controller 456, which may be configured to communicate with external devices such as input devices (e.g., keyboard, mouse, pen, voice input device, touch input device, etc.) or other peripheral devices (e.g., printer, scanner, etc.) via one or more I/O ports 458. An example communication device 446 includes a network controller 460, which may be arranged to facilitate communications with one or more other computing devices 462 over a network communication link via one or more communication ports 464.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 400 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 400 may also be implemented as a personal computer including both laptop computer and non-laptop computer configurations.

### Example 1

### Generating a Financial Incentive Based on an Environmental Score

A vehicle in City A will include a sensor device configured to monitor nitrogen oxide (NOₓ) gas emitted by the vehicle. In City A, the permissible limit of NOₓ gas is 0.08 ppm as predetermined by the City A government. The sensor device will be in communication with a processing unit inside of the vehicle that monitors the sensor device output and distance data from the vehicle odometer. For every 0.01 ppm in excess of the predetermined limit, the processing unit will increment the environmental score by 1. At the end of each month, the processing unit will communicate the cumulative environmental score to the City A government.

The City A government will generate a financial incentive by assigning a flat multiplier of 20 dollars per environmental score, and sending the financial incentive as an invoice to all vehicle owners on a monthly basis. As such, a driver who drives 20 kilometers at a measured NOₓ emission rate of 0.10 ppm will be invoiced 8 dollars for the trip: (0.02 ppm×20 km)×(1 environmental score per ppm)×(20 dollars per environmental score).

### Example 2

### Generating a Financial Incentive Based on an Environmental Score

A vehicle in City A will include a sensor device configured to monitor sulfur oxide (SOₓ) gas emitted by the vehicle. In City A, the permissible limit of SOₓ gas is 0.08 ppm as predetermined by the City A government. The sensor device will be in communication with a processing unit inside of the vehicle that monitors the sensor device output and distance data from the vehicle odometer. For every 0.01 ppm in excess of the predetermined limit, the processing unit will increment the environmental score by 1. At the end of each month, the processing unit will communicate the cumulative environmental score to the City A government.

The operator of a vehicle in City A that does not generate any detectable SOₓ or generates an amount below the 0.08 ppm limit will be provided with a financial incentive by the City A government by providing a rebate, for example, based on the invoice value of an average driver. For example, if the average driver receives an invoice of 5 dollars for a particular trip, then the second vehicle will receive a rebate or credit from City A for 5 dollars for the same trip.

### Example 3

### Generating a Financial Incentive Based on an Environmental Score Incorporating a Time-of-Day Factor

A vehicle in City B will include a sensor device configured to monitor nitrogen oxide (NOₓ) gas emitted by the vehicle. In City B, the permissible limit of NOₓ gas is 0.08 ppm as predetermined by the City B government. The sensor device will be in communication with a processing unit inside of the vehicle that monitors the sensor device output and distance data from the vehicle odometer. For every 0.01 ppm in excess of the predetermined limit, the processing unit will increment the environmental score by 1. The environmental score determined based on the predetermined NOₓ limit will be multiplied by a time-of-day factor configured to discourage drivers from driving during peak congestion times. At the end of each month, the processing unit will communicate the cumulative environmental score to the City B government.

The time-of-day factor will equal 1 during off-peak times, but will increase linearly from 1 to 3 between 7:00 and 8:00 a.m., and will decrease linearly from 3 to 1 between 9:00 and 10:00 a.m. Similarly, the time-of-day factor will increase linearly from 1 to 3 between 4:00 and 5:00 p.m., and will decrease linearly from 3 to 1 between 7:00 and 8:00 p.m. The City B government will assign a flat multiplier of 20 dollars per environmental score and will send an invoice to all vehicle owners on a monthly basis.

The City B government will generate a financial incentive by assigning a flat multiplier of 20 dollars per environmental score and will send the financial incentive as an invoice to all vehicle owners on a monthly basis. As such, a driver who drives 20 kilometers at a measured NOₓ emission rate of 0.10 ppm between 8:00 and 8:30 a.m. will be invoiced 24 dollars for the trip: ((0.02 ppm×20 km)×3 time-of-day factor)×(1 environmental score per ppm)×(20 dollars per environmental score). A driver who drives 20 kilometers at a measured NOₓ emission rate of 0.10 ppm between 11:00 and 11:30 a.m. will be invoiced 8 dollars for the trip: ((0.02 ppm×20 km)×1 time-of-day factor)×(1 environmental score per ppm)×(20 dollars per environmental score).

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A method for controlling traffic pollution, the method comprising:
providing a vehicle having at least one pollution recording unit configured to provide an environmental score based on at least one pollution behavior of the vehicle, and wherein the environmental score is associated with a financial incentive; and
calculating the financial incentive based on the environmental score at a processing device operably connectable to the pollution recording unit.

2. The method of claim 1, wherein the environmental score increases as an environmental impact of the vehicle increases, and decreases as an environmental impact of the vehicle decreases.

3. The method of claim 1, wherein the financial incentive is a fee associated with operation of the vehicle, and wherein the fee increases as the environmental score increases.

4. The method of claim 2, wherein the financial incentive is a cash rebate or service credit from a car manufacturer or car dealership, and wherein the cash rebate or service credit decreases as the environmental score increases.

5. The method of claim 2, wherein the financial incentive is a tax credit or refund, and wherein the tax credit or refund decreases as the environmental score increases.

6. The method of claim 1, wherein the vehicle comprises an exhaust sensor operably connected to the at least one pollution recording unit and configured to determine a pollutant amount in exhaust,
wherein the at least one pollution behavior is proportional to the pollutant amount in the exhaust; and
wherein the environmental score increases as the pollution amount in the exhaust increases.

7. The method of claim 6, wherein the pollutant amount in the exhaust comprises the amount of carbon dioxide, carbon monoxide, nitric oxide, nitrogen dioxide, sulfur dioxide, nanoparticles, or any combination thereof contained within the exhaust.

8. The method of claim 1, wherein the at least one pollution behavior comprises a driving time of the vehicle and wherein the environmental score is decreased if the driving time is in an off-peak time having historically low traffic levels.

9. (canceled)

10. The method of claim 1, wherein the vehicle is configured to receive traffic congestion information via a navigation system configured to provide at least one driving route having an associated congestion score related to traffic levels along the at least one driving route.

11. (canceled)

12. The method of claim 10, wherein the at least one pollution behavior comprises a driving route of the vehicle, and wherein the environmental score increases as the congestion score of the driving route increases.

13. The method of claim 1, wherein the vehicle is adapted to receive pollution information via a navigation system configured to provide at least one driving route having an associated air pollution degree related to air quality along the at least one driving route.

14-16. (canceled)

17. A system for measuring a vehicle's pollution, the system comprising:
a pollution monitoring unit in electronic communication with a vehicle, the pollution monitoring unit configured to provide an environmental score based on at least one pollution behavior of the vehicle, wherein the environmental score is associated with a financial incentive; and
a processing device operably connected to the pollution monitoring unit and configured to calculate the financial incentive based on the environmental score.

18-21. (canceled)

22. The system of claim 17, further comprising an exhaust sensor operably connected to the at least one pollution recording unit and configured to determine a pollutant amount in exhaust, wherein the at least one pollution behavior is proportional to the pollutant amount in the exhaust, and wherein the environmental score increases as the pollution amount in the exhaust increases.

23. The system of claim 22, wherein the pollutant amount in the exhaust comprises the amount of carbon dioxide, carbon monoxide, nitric oxide, nitrogen dioxide, sulfur dioxide, nanoparticles, or any combination thereof contained within the exhaust.

24-28. (canceled)

29. The system of claim 17, further comprising a navigation system configured to provide at least one driving route having an associated air pollution degree related to air quality along the at least one driving route.

30. (canceled)

31. The system of claim 29, wherein the at least one pollution behavior comprises a driving route of the vehicle, and wherein the environmental score increases as the air pollution degree of the driving route increases.

32. (canceled)

33. A vehicle comprising:
a propulsion device configured to emit a quantity of exhaust; and
a pollution measuring system comprising a pollution monitoring unit in electronic communication with the vehicle, the pollution monitoring unit configured to:
provide an environmental score based on at least one pollution behavior of the vehicle and the quantity of exhaust emitted by the propulsion device, wherein the environmental score is associated with a financial incentive; and
operably connect to a processing device configured to calculate the financial incentive based on the environmental score.

34. The vehicle of claim 33, wherein the pollution measuring system further comprises at least one exhaust sensor operably connected to the at least one pollution recording unit and configured to determine a pollutant amount in the exhaust, wherein the environmental score increases as the pollution amount in the exhaust increases.

35. The vehicle of claim 33, further comprising a navigation system configured to measure distance travelled by the vehicle, at least one driving route taken by the vehicle, an associated congestion score related to traffic levels along the at least one driving route, and an associated air pollution degree related to air quality along the at least one driving route.

36. (canceled)

37. The vehicle of claim 35, wherein the environmental score is proportional to at least one of the congestion score and the air pollution degree.

38. (canceled)

39. The vehicle of claim 33, wherein the propulsion device is an electric motor.

40. The vehicle of claim 33, wherein the vehicle is one of an automobile, a truck, a watercraft, and an aircraft.

41. A method of providing a financial incentive to an operator of a vehicle, the method comprising:
receiving an environmental score for a vehicle, wherein the environmental score is determined by a pollution recording unit;
determining a financial incentive based upon the environmental score; and
providing the financial incentive to the operator of the vehicle.

42. The method of claim 41, wherein the environmental score increases as an environmental impact of the vehicle increases, and decreases as an environmental impact of the vehicle decreases.

43. (canceled)

44. (canceled)

45. The method of claim 42, wherein the financial incentive is a tax credit or refund, and wherein the tax credit or refund decreases as the environmental score increases.

46. (canceled)
